(19) United States
(12) Patent Application Publication
(10) Pub. No.: US 2017/0098236 A1
(43) Pub. Date: Apr. 6, 2017

(54) EXPLORATION OF REAL-TIME ADVERTISING DECISIONS

(71) Applicant: Yahoo! Inc., Sunnyvale, CA (US)

(72) Inventors: Kuang-chih Lee, Union City, CA (US); Quan Lu, San Diego, CA (US); Giovanni Gardelli, San Francisco, CA (US); Donglin Niu, San Jose, CA (US)

(73) Assignee: Yahoo! Inc., Sunnyvale, CA (US)

(21) Appl. No.: 14/873,757

(22) Filed: Oct. 2, 2015

(51) Int. Cl. G06Q 30/02; G06F 17/30; G06Q 10/06

(52) U.S. Cl. CPC G06Q 30/0244; G06Q 10/067; G06Q 30/0247; G06Q 30/0275; G06F 17/30528

(57) ABSTRACT

Described herein are example systems and operations for enhancing response prediction and bidding decision making. A feature recommendation controller may include a factorization machine that generates a set of combinations of contextual and advertiser features yielding high expected response rates. A bidding controller may implement a multi-arm bandit system that uses Thompson sampling to select an optimal one of the feature combinations that corresponds to a highest expected response rate. The bidding controller may compare the corresponding highest expected response rate with a threshold response rate associated with a pacing rate to determine whether to place a bid for a received ad request.

### BACKGROUND

Increasingly, advertising is being integrated with online content, and vice versa. Online audiences are demanding free content or at least content delivered at below market prices. Because of this demand, publishers and content networks may be delivering advertising with such content to compensate for lost profits. It has also been found that advertising can be acceptable to online audiences if the advertising is useful to audience members.

Online advertising is one of the fastest growing industries with tens of billions of total spending projected in 2015 in the United States alone. Using those billions more effectively could have dramatic results for the industry. One of the most significant trends in online advertising in recent years is real-time bidding (RTB), or sometimes referred to as programmatic buying. In RTB, advertisers have the ability of making decisions programmatically whether and how much to bid for an impression that would lead to the best expected outcome (action). Bidding algorithms can use the contextual and user behavior data to select the best ads, in order to enhance the effectiveness of online advertising. Also, knowing which content items generate certain user interactions online is important to online markets.

Demand-side platforms (DSPs) are important entities in the mark that may assist advertisers in managing their campaigns and enhance their bidding activities. DSPs may do so by acquiring inventory through many different direct buying ad-networks or real-time bidding (RTB) ad exchanges. Advertisers may setup campaigns and define targeting constraints in DSPs. The DSPs may collect various types of information, such as information about users, pages, ads, Using that information, DSPs may make decisions for advertisers to reach their goals, such as those involving brand advertising and/or those that set certain performance metrics defined by cost-per-click (CPC), cost-per-action (CPA), cost-per-complete-view (CPCV), or cost-per-installation (CPI), as examples.

Various campaign optimization approaches have been developed in order for advertisers to reach their goals. Such approaches have focused on evaluating bid prices for each impression based on response prediction (e.g., click-through-rate (CPC) and action-rate (AR) prediction). In order to perform response prediction, these campaign optimization approaches may collect a certain amount of response events, which may be used to train a machine learning model. However, when a new campaign begins, a sufficient amount of response feedback information is not available to adequately train the machine learning model. In turn, the machine learning model is unable to reliably perform response prediction. This situation may be referred to as the cold start problem. When faced with the cold start problem, advertisers may be willing to spend more money than they otherwise would with a reliably trained model in order to jump start and expedite the learning process.

Resolution of such engineering problems is pertinent considering the competitive landscape of online advertising. The resolution of these technical issues can benefit advertisers in providing more effective response prediction and enhanced implementation of bidding strategies. In addition, through the response prediction analysis, new campaigns may more quickly become competitive among other similar campaigns bidding on the same inventory. The technologies described herein set out to solve technical problems associated with response prediction in computer-implemented real time bidding environments, in which servers other similar computing systems perform real-time bidding decisions.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 is a block diagram of an information system that includes example devices of a network that can communicatively couple with an example system that makes feature combination recommendations and performs bidding decisions based on those feature combinations.

FIG. 2 illustrates displayed content items (which includes ad items) of example screens rendered by client-side applications.

FIG. 3 is a block diagram of feature commendation and bidding system that may be communicatively coupled with the example devices of FIG. 1.

FIG. 4 is a block diagram of components of a feature recommendation system of the system of FIG. 3.

FIG. 5 is a block diagram of components of a bidding system of the system of FIG. 3.

FIG. 6 is a graphical representation of an example distribution of ad request as a function of response rate.

FIG. 7 is a flow chart of an example method of generating a plurality of feature recommendations.

FIG. 8 is a flow chart of an example method of performing bidding decisions for incoming ad requests from over a network.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is not intended to be limiting on the scope of what is claimed.

Aspects of systems and operations, described herein, labeled as “first”, “second”, “third”, and so on, should not necessarily be interpreted to have chronological associations with each other. In other words, such labels are used to merely distinguish aspects of the systems and operations described herein, unless the context of their use implies or expresses chronological associations.

### Overview

By way of introduction, the below embodiments relate to feature recommendation and bid decision making. In one example embodiment, a system for enhanced prediction of response events may include a feature recommendation controller and a bidding controller. The feature recommendation controller may be configured to generate a model parameter set of model parameters corresponding to a plurality of feature combinations of contextual features and advertisement features. The model parameter set may be generated based on training data associated with the contextual features and the advertisement features. The feature recommendation controller may further be configured to select, among the model parameters in the model parameter set, a number of highest-ranked model parameters, wherein the number of highest-ranked model parameters corresponds to a set of feature combinations of the plurality of feature combinations that is expected to yield the highest response rates among the plurality of feature combinations. In addition, the feature recommendation controller may be configured to generate an arms set that comprises the set of feature combinations. The bidding controller may be configured to: receive an incoming ad request; and send a bid over a network to an exchange for the incoming ad request in response to a maximum sample corresponding to the set of feature combinations in the arms set being greater than a threshold response rate.

In a second embodiments, a method for enhanced bidding on received ad requests may be performed. The method may include: generating, with a multi-arm bandit module, a plurality of beta distributions, each beta distribution being associated with one of a plurality of arms in an arms set, each arm of the plurality of arms being associated with a feature combination of a plurality of feature combinations of contextual features and advertisements features; sampling, with the multi-arm bandit module, each of the plurality of beta distributions to generate a plurality of beta distribution samples; selecting, with a sample selection module, a maximum sample of the plurality of beta distribution samples, the maximum sample being associated with an optimal arm of the plurality of arms; comparing, with a comparator module, the maximum sample with a response rate threshold associated with a pacing rate; and sending, with a bidding module, a bid for a received ad request over a network to an exchange auction server in response to the maximum sample exceeding the response rate threshold.

In another embodiment, a non-transitory computer readable medium may include: instructions executable by a processor to generate a set of predicted response event values based on training data for different feature combinations of contextual features and advertisement features; instructions executable by the processor to iteratively update an initial model parameter set using the set of predicted response event values to generate an updated model parameter set; instructions executable by the processor to generate an arms set comprising a subset of the different feature combinations, the subset corresponding to a number of highest-ranked model parameters of the updated model parameter set; instructions executable by the processor to generate a plurality of beta distribution samples, each beta distribution of the plurality of beta distribution samples corresponding to one of the feature combinations in the subset; and instructions executable by the processor to send a bid for a received ad request over a network to an exchange auction server in response to a comparison between one of the plurality of beta distribution samples and a response rate threshold.

In sum, a feature recommendation and bidding system may provide a hybrid offline and online unified framework that combines collaborative filtering and multi-arm bandit systems to improve response prediction. The system when be used as an approach to addressing the cold start problem for new online advertising campaigns in a marketplace.

Other embodiments are possible, and each of the embodiments can be used alone or together in combination. Accordingly, various embodiments will now be described with reference to the attached drawings.

### DESCRIPTION OF THE DRAWINGS

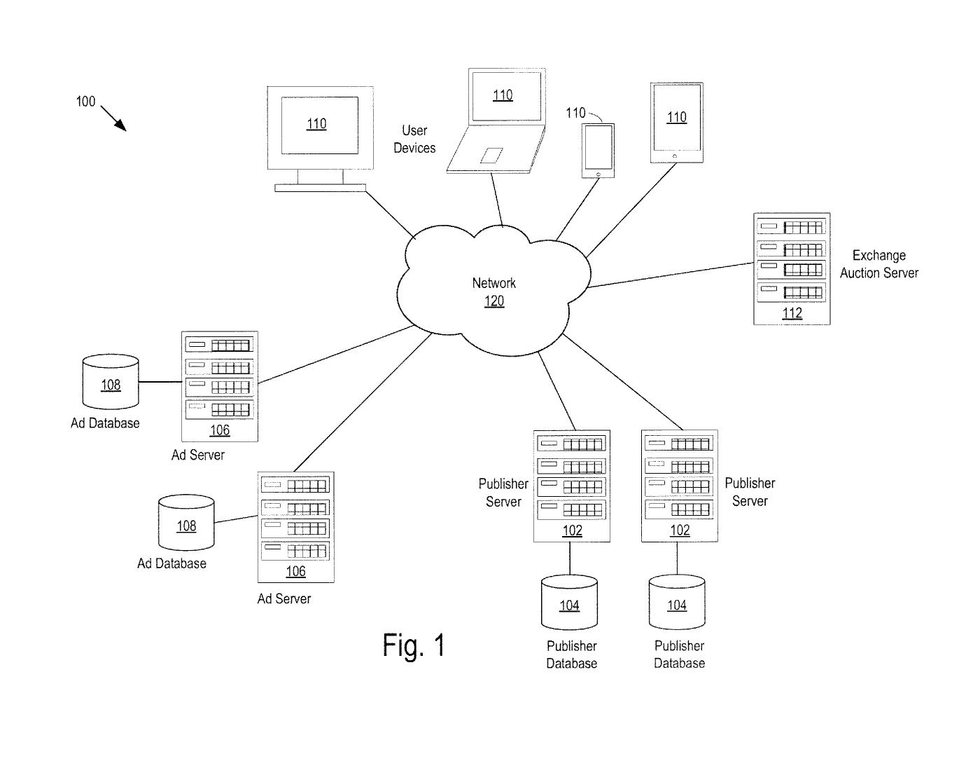

FIG. 1 illustrates a block diagram of an information system 100 that includes example devices of a network that can communicatively couple with an example system that makes feature combination recommendations and performs bidding decisions based on those feature combinations. The information system 100 in the example of FIG. 1 includes publisher servers 102, publisher databases 104, ad servers 106, ad databases 108, user devices 110, and an exchange auction server 112. The servers and databases can be communicatively coupled over a network 120, which may be a computer network. The aforementioned may each be one or more server computers.

In the information system 100, the publisher servers 102 may provide content (also referred to as medium or electronic property) that a user device 110 wants to access and/or retrieve. Non-limiting examples of content include a website, a webpage, web-based search results provided by a search engine, a software application (app), a video game, or e-mail. Example publisher servers may include a content server or a search engine server. By providing the content, the publisher servers 102 may generate advertising inventory, which may be a supply of opportunities to display advertising in, along with, or through the provided content. The publisher server 102 may offer to sell its advertising inventory and/or send requests to submit offers or bids to buy its advertising inventory. When advertising inventory is purchased, the purchaser may obtain one or more ad impressions. Each ad impression may be a display of an advertisement (ad) with a user device 110.

A publisher server 102 may access content data or other information defining and/or associated with the content it provides either from a publisher database 104 or from another location accessible over the network 120. The publisher server 102 may communicate the content data to other devices over the network 120. Additionally, the publisher server 102 may provide a publisher front end to simplify the process of accessing the content data. The publisher front end may be a program, application or software routine that forms a user interface. In a particular example, the publisher front end is accessible as a website with electronic properties that an accessing publisher may view on a publisher device. The publisher may view and edit content data using the publisher front end.

The publisher server 102 may include logic and data operative to format the content data for communication to a user device. The content data may be formatted to a content item that may be included in a stream of content items provided to a user device 110. The formatted content items can be specified by appearance, size, shape, text formatting, graphics formatting and included information, which may be standardized to provide a consistent look for content items in the stream.

The information system 100 may be accessible over the network 120 by advertiser devices and audience devices, which may be desktop computers (such as device 122), laptop computers (such as device 124), smartphones (such as device 126), and tablet computers (such as device 128). An audience device can be a user device that presents online content items, such as a device that presents online advertisements to an audience member. In various examples of such an online information system, users may search for and obtain content from sources over the network 120, such as obtaining content from the search engine server 106, the ad server 108, the ad database 108, the content server 112, and the content database 114. Advertisers may provide content items for placement on online properties, such as web pages, and other communications sent over the network to audience devices. The online information system can be deployed and operated by an online services provider, such as Yahoo! Inc.

The ad server 106 may be one or more servers. Alternatively, the ad server 106 may be a computer program, instructions, and/or software code stored on a computer-readable storage medium that runs on one or more processors of one or more servers. The ad server 106 may operate to serve advertisements (ads) to audience devices for display or reception of the ads by a user device 110. An advertisement may include data of a variety of different types, such as text data, graphic data, image data, video data, or audio data. The advertisement data may also include data defining content item information that may be of interest to a user of an audience device. An advertisement may further include data defining links to other online properties reachable through the network 120.

The ad server 106 may include logic and data operative to format the advertisement data for communication to an audience member device, which may be any of the user devices 110. The advertisement data may be formatted for inclusion in a stream of content items and advertising items provided to a user device 110. The formatted items can be specified by appearance, size, shape, text formatting, graphics formatting and included information, which may be standardized to provide a consistent look for items in the stream. The ad server 106 may be in data communication with the ad database 108. The ad database 108 may store information, including data defining advertisements and/or advertisement creatives, to be served to the user devices 110. This advertisement data may be stored in the ad database 108 by another data processing device or by an advertiser.

Further, the ad server 106 may be in data communication with the network 120. The ad server 106 may communicate advertisement data and other information associated with advertisements to devices over the network 120. This advertisement data and other information may be communicated to a user device 110, such as using the ad server 106 or another advertiser device being operated by an advertiser. An advertiser operating an advertiser device may access the ad server 106 over the network 120 to access the advertisement data or other information. This access may include developing creatives, adding advertisement data, or deleting advertisement data, as non-limiting examples. The ad server 106 may then provide the advertisement data to other network devices or servers in the information system 100.

The ad server 106 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communications to an audience device. The advertiser front end may also provide a graphical user interface for simulating campaigns according to operations performed by the enhanced targeting server 116 and/or the AR lift server 130.

In addition to communicating advertisements over the network 120, the ad servers 106 may determine whether to purchase advertisement inventory and for how much. The publisher servers 102 and the ad servers 106 may participate in an auction-based marketplace in which the publisher servers 102 may serve requests (herein referred to as ad requests) for offers to buy advertisement inventory. In response, the ad servers 106 may submit bids to buy the inventory when they so choose. The bids may be submitted in a real-time bidding (RTB) format. For purposes of the present description, the ad servers 106 may be operating in the auction-based marketplace under the direct control of the advertiser, or alternatively as a representative or proxy of the advertisement, such as a demand-side platform (DSP) for example.

The auction-based market place may be conducted through the exchange auction server 112. Rather than the publisher servers 102 sending the ad requests, the exchange auction server 112 may be the network entity in the system 100 sending the ad requests. The sending of an ad request may be initiated when the opportunity of an ad impression occurs, such as when a user device 110 accesses certain content provided by a publisher server 102. For example, the user device 110 may navigate to a website or access a webpage, thus creating an opportunity for an advertisement to be displayed. The exchange auction server 112 may then send an ad request to the ad servers 106, requesting bids to purchase an ad impression for the content creating the opportunity. The ad servers 106 may determine whether they want to bid, and if they do so, may send bids to the exchange auction server 112 with their bid amounts. The exchange auction server 112 may then determine the winning bid among the submitted bids, and have the advertisement associated with the winning bid displayed in conjunction with the content that created the opportunity in the first place. Further description of the bid decision making is described in further detail below.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as WINDOWS SERVER, MAC OS X, UNIX, LINUX, FREEBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include FLICKER, TWITTER, FACEBOOK, LINKEDIN, or a personal user site (such as a blog, vlog, online dating site, etc.). An online server system may also host a variety of other sites, including business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

Each of the user devices 110 (which may also be referred to as advertiser client devices, an audience client device, or simply audience device), may include a data processing device that may access the information system 100 over the network 120. The user devices 110 may be operative to interact over the network 120 with any of the servers or databases described herein. The user devices 110 may implement a client-side application for viewing electronic properties and submitting user requests, such as requests to access content provided by the publisher servers 102. The use devices 110 may communicate data to the information system 100, including data defining electronic properties and other information. The user devices 110 may receive communications from the information system 100, including data defining electronic properties and advertising creatives.

The user devices 110 may be any computing device capable of sending or receiving signals, such as via a wired connection and/or wirelessly, over the network 120. Example user devices may include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user devices 110 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

The user devices 110 may include or may execute a variety of operating systems, including a personal computer operating system, such as a WINDOWS, IOS OR LINUX, or a mobile operating system, such as IOS, ANDROID, or WINDOWS MOBILE, or the like. The user devices may include or may execute a variety of possible applications, such as a client software application enabling communication with other devices, such as communicating messages, such as via email, short message service (SMS), or multimedia message service (MMS), including via a network, such as a social network, including, for example, FACEBOOK, LINKEDIN, TWITTER, FLICKR, or GOOGLE+, to provide only a few possible examples. The user devices may also include or execute an application to communicate content, such as, for example, textual content, multimedia content, or the like. A user devices may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities.

Also, the described methods and systems may be implemented at least partially in a cloud-computing environment, at least partially in a server, at least partially in a client device, or in a combination thereof.

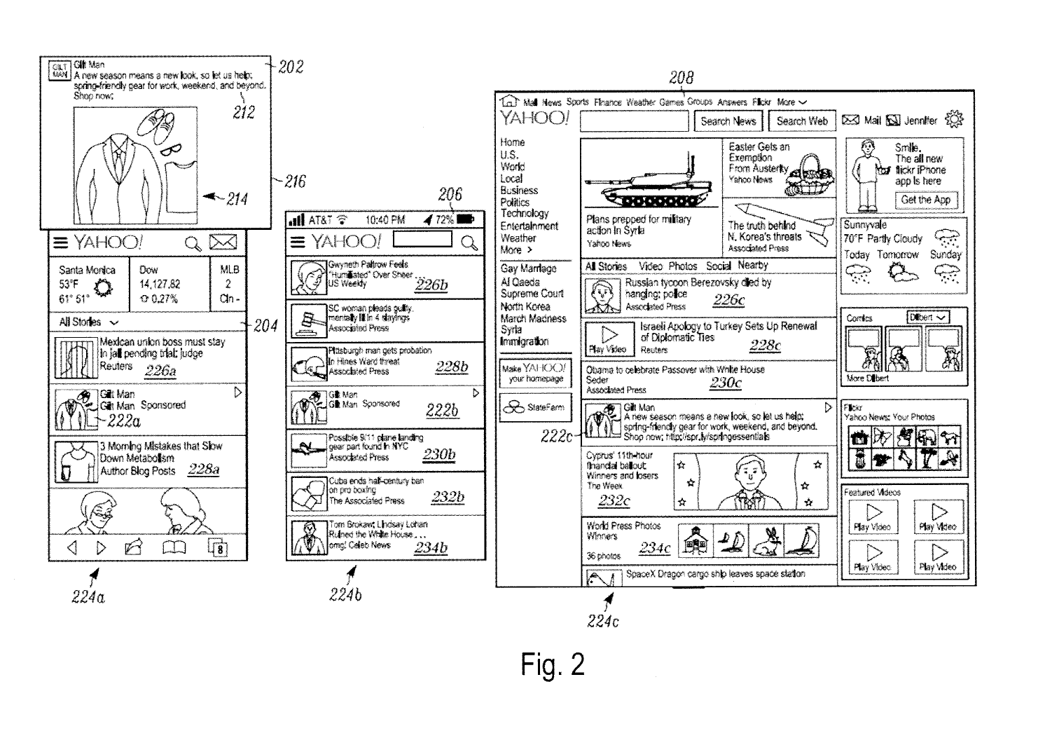

FIG. 2 illustrates displayed content items (including ad items) of example screens rendered by client-side applications of the user devices 110. The content items displayed may be provided by the publisher servers 102 and the ad servers 106. In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on a user device 110 but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers, e.g., the publisher servers 102 (FIG. 1). These content items may include advertising components. Each of the streams 224a, 224b, and 224c may include a number of content items and advertising items.

The content items positioned in any of streams 224a, 224b, and 224c may include news items, business-related items, sports-related items, etc. Further, in addition to textual or graphical content, the content items of a stream may include other data as well, such as audio and video data or applications. Content items may include text, graphics, other data, and a link to additional information. Clicking or otherwise selecting the link may re-direct the application (e.g., browser) on the user device 110 to an electronic property referred to as a landing page that contains the additional information. While the example streams 224a, 224b, and 224c are shown with a visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to campaign control.

Referring back to FIG. 1, when an ad server 106 receiver an ad request, the ad server may determine whether to bid and if so, may also determine an advertisement and a bid amount to accompany the bid in accordance with an advertisement campaign. The advertisement campaign may identify an N-number of advertisements in an advertisement pool, a time period that the campaign is to run, a total budget, an expected number of impressions, as well as targeting information, such as a target demographic description for example. Each advertisement in the advertisement in the advertisement pool may be associated with an advertisement feature vector A, such that a pth advertisement in the advertisement pool may be associated with an advertisement feature vector Aₚ. Each advertisement feature vector Aₚ may include and/or be indicative of one or more advertisement features of the associated advertisement. An advertisement feature may be a descriptor or other information that describes or characterizes the advertisement. Non-limiting examples of an advertisement feature may be the name of the advertiser and the size (e.g., pixel dimension) of the advertisement.

The ad server 106 may receive an M-number of ad requests ADR within a given time slot, which may arrive sequentially in an order identified by an index q. Each qth ad request ADR_{q} may be associated with a contextual feature vector I_{q}, where each contextual feature may include and/or be indicative of one or more publisher features and/or one or more user features. A publisher feature in a qth contextual feature vector I_{q} may be a descriptor or other information that describes or characterizes the content associated with the qth ad request ADR_{q} (i.e., the content that created the opportunity for which the qth ad request ADS_{q}) was generated. A non-limiting example of a publisher feature may include a domain name of the publisher. A user feature in a qth contextual feature vector I_{q} may be a descriptor or other information that describes or characterizes a user of a user device 110 that requested access of the content. A non-limiting example of a user feature may include an age of the user of the user device 110.

For a given advertiser, the instantaneous reward of bidding on an ad request ADR may correspond to the likelihood that sending a bid for the ad request ADR will yield a response event. Example response events may include a user click on the associated advertisement by the user device 110 when it is displayed (herein referred to simply “click-through” or “click”) or a conversion, which may be an action taken by a user after the advertisement is shown, with or without a click occurring. Non-limiting example actions may include a purchase of a product on the advertiser's website, signing up for a newsletter, or requesting a quote.

The campaign may also include a campaign objective, which generally may be based on the campaign's budget and the number of impressions. Qualitatively, the campaign objective may be, for all of the incoming ad requests ADR with associated contextual feature vectors that are received in a time period or interval, to select advertisements in the advertisement pool that maximize the probability of a response event, such that the expected outcome of the probabilities of the response event in that time period is maximized, and such that, for all of the incoming ad requests ADR in that time period, the inventory cost once the associated impressions are served does not exceed the allocated campaign budget. Mathematically, the campaign objective may be represented by the following formula:

$$max 𝔼 [ {\sum }_{q = 1}^{M} max p ( {r}_{q} \vert {I}_{q} , {A}_{p} ) ] , such that {\sum }_{q ∈ {𝕁}_{t}} {c}_{q} \leq {b}_{t} , \qquad ( 1 )$$

where I_{q} is a qth contextual feature vector associated with a qth ad request ADR_{q}, Aₚ is a pth advertisement feature vector associated with a pth advertisement feature vector, [symbol] is the set of advertisements in the advertisement pool, r_{q} is a qth response event associated with the qth ad request ADR_{q}, M is the total number of incoming ad requests ADR received over the time period t, c_{q} is the qth inventory cost once a qth impression associated with the qth ad request ADR_{q} is served, bₜ denotes the allocated budget of the campaign over a time period t, and [symbol] ₜ represents an index set of ad requests ADR that are received in the time period t.

To select the advertisements that yield a maximum expected probability of response events for the M-number of ad requests ADR, determine whether to make bids for those ad requests ADR, and for what amounts in order meet campaign objects, the ad server 106 making the determinations may have received a sufficient amount of feedback of ad impression and associated response event information. However, when an ad server 106 with a new campaign first enters a marketplace, the ad server 106 may not yet have received a sufficient amount of feedback information as a result of bidding and winning bids to make those decisions. As a consequence, other ad servers 106 that have been implementing campaigns contending for the same inventory for a longer amount of time and that have obtained a sufficient amount of feedback information may have an advantage in the marketplace over the ad server 106 executing a new campaign. These ad-servers 106 executing the longer-established campaigns may have the advantage in choosing advertisements that yield high response event rates and/or optimum bid amounts to win the bids, and ultimately in meeting their campaign objectives. This disadvantage in the marketplace for ad servers 106 implementing new campaigns may be referred to as the cold start problem.

Ad servers 106 confronted with the cold start problem for a new campaign may not be able to make optimal bidding decisions. As examples, the ad servers 106 may bid too low and not win a bid, bid too high such that they over spend to win the bid, or bid with an ad and/or with a bid amount for inventory that do not have a high likelihood of a response event. As a result, the ad server's execution of the campaign to meet the campaign objectives is less than optimal.

The process during which an ad server 106 makes bids to gain a sufficient amount of feedback information to enable it to make optimal bidding decisions may be referred to as an exploration process. In one type of exploration process that addresses the cold start problem, an ad server 106 implementing a new campaign may initially bid higher and/or more aggressively in order to increase the rate at which it wins bids and thus increases the rate at which it receives feedback information. However, it may be desirable for an ad server 106 to make optimal bidding decisions for a new campaign and be competitive with the other campaigns as quick as possible and/or without having to (or at least minimally having to) bid higher and/or more aggressively.

One approach that addresses the cold start problem may use collaborative filtering, where response results from similar campaigns that have a sufficient amount of response events may be used in order to make response predictions. However, this type of collaborative filtering may not be completely effective if the response results from the similar campaigns, including those involving conversions or app installations cannot be shared across different advertisers. Another approach that addresses the cold start problem may implement a multi-arm bandit system that explores or analyzes different combinations (arms) of features to make its bidding decisions. However, the dimensionality of the contextual features may be so large that practical implementations of the multi-arm bandit system may analyze only a small amount of arms that include only advertisement features.

The present description describes a feature recommendation and bidding system that combines a collaborative filtering system with a multi-arm bandit system to make bidding decisions. The collaborative filtering system may be a part of the feature recommendation part of the system and may include a factorization machine that uses a training data set to generate a limited set of ranked combinations of contextual and advertiser features yielding high expected response rates. The multi-armed bandit system may be a component of the bidding part of the system and may receive the limited set of ranked feature combinations from the feature recommendation part. In response to receiving the feature combinations, the multi-arm bandit system, using Thompson sampling, may select an optimal one of the feature combinations, where the optimal feature combination may be determined to provide the highest expected reward (i.e., the highest likelihood of a response event) and/or correspond to the highest expected response rate. The bidding part may then compare the corresponding highest expected response rate with a threshold rate that represents a minimum threshold rate for a sufficient number of ad requests to satisfy a pacing rate.

The feature recommendation part of the system may be performed “offline,” meaning that it may be performed independent of and/or without being in response to a received ad request. In contrast, the bidding part may be performed “online,” meaning that it may be performed and affected by incoming ad requests during real-time bidding scenarios. For a received incoming ad request, if the determined corresponding highest expected response rate exceeds the threshold, then the bidding part may determine to submit a bid and send the bid to the exchange auction server 112. Alternatively, if the highest expected response rate does not exceed the threshold, then the bidding part may determine not to submit a bid, and simply drop the ad request.

Such a hybrid offline and online unified framework that combines the collaborative filtering and multi-arm bandit systems may improve response prediction when addressing the cold start problem. For example, as explained above, during real-time bidding on ad requests, ad servers 106 receive ad requests from over the network 120 and have to make real-time bidding decisions, such as within milliseconds, on whether to bid on the ad request. During the real-time bidding process, there is not enough time for the ad server 106 to present the received ad request to a person and let the person decide on whether to bid on the received ad request. In addition, not only must the ad server 106 make the bidding decision quickly, but must also do so intelligently, taking into consideration a campaign budget and a likelihood of the associated ad yielding a response event, should the bid be won and the ad served. In the context of the cold start problem, there is a technical problem of how to train and/or provide certain information to ad servers 106 so that they may be configured to make their real-time bidding decision for new campaigns in an optimally intelligent manner despite having little to no historical bidding data for that new campaign. While historical data for other campaigns may be available as training data, the feature combinations of contextual and advertisement features that may be available may be in the millions, billions, or trillions, far more than an ad server 106, let alone people, can handle in real-time bidding.

The offline collaborative filtering part of the system can analyze these extremely large quantities of feature combinations to select and rank, from these large quantities of feature combinations, a very limited or small number (i.e., m-number) of feature combinations. The m-number of feature recommendations may be of an order that is much smaller than the total number of feature combinations, such as 10, 25, or 100—much smaller than the millions, billions, or trillions of feature combinations available in the historical training data. The offline collaborative filtering part can provide these limited number of feature combinations to the online bidding part as feature-combination recommendations, which the online bidding part can then use to perform its online bidding. This limited number of highest-ranked recommendations is a much more manageable amount, compared to the total number of feature combinations, for the online part when making bidding decisions. Also, not only can the collaborative filtering part filter millions/billions/trillions of feature combinations down to a much smaller number (e.g., 10, 25, 100), but it can do so in a small amount of time, such as in an hour, which is important in the cold start problem since how fast an ad server 106 can make optimal bidding decisions for a new campaign is of utmost importance.

In addition, using feedback information, such as bidding results data (e.g., impressions, response events, etc.) from the online bidding part for the campaign (e.g., for the new campaign), the offline feature recommendation part can update and provide a new or updated set of feature-combination recommendations to the online bidding part at time periods or intervals, such as predetermined time periods or intervals. Since the offline feature recommendation part can provide feature-combination recommendations in a relatively short amount of time, the time periods may correspondingly relatively short, such as in one-hour time intervals.

Also, as described in further detail below, the online recommendation part's use of Thompson sampling provides a technical solution that an ad server 106 can employ for analyzing or processing the feature-combination recommendations in order to determine a best feature-combination recommendation for a received ad request, and then to use that best feature-combination recommendation to determine whether to bid on the ad request. The online recommendation part further considers budgetary aspects, such as pacing rate, of the campaign to make its decision, further adding to the intelligent decision-making capabilities of the online bidding part.

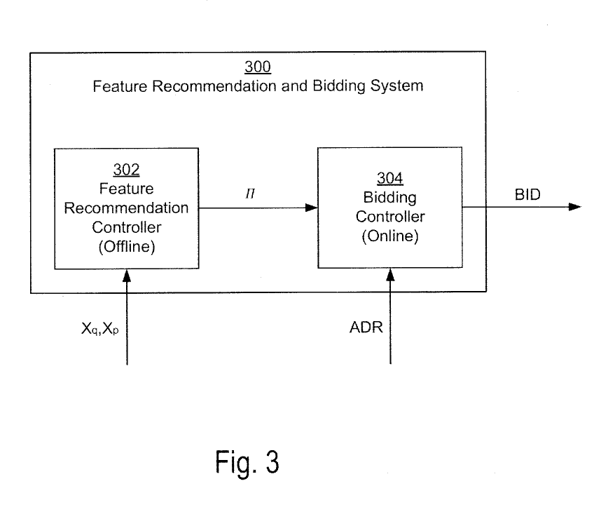

FIG. 3 illustrates a block diagram of an example feature recommendation and bidding system 300. The feature recommendation and bidding system 300 of FIG. 3 may be included in, in coupled communication with, and/or used by the ad servers 106 to make bidding decisions. As shown in FIG. 3, the system 300 may include a feature recommendation controller 302 and a bidding controller 304. The feature recommendation controller 302 and the bidding controller 304 may be the same controller or components of the same controller or they may be different controllers. In addition or alternatively, the feature recommendation controller 302 and the bidding controller 304 may be included in the same ad server 106 or other computing device, or included in different ad servers 106 or other computing devices. Where the feature recommendation controller 302 and the bidding controller 304 are included in different ad servers 106 or other computing devices, the recommendation controller 302 and bidding controller 304 may communicate with each other over a network, such as the network 120 shown in FIG. 1. Also, the controllers 302, 304 may take the form of processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. The controllers 302, 304 may be configured with hardware, software, and/or firmware to perform the various functions described below and shown in the flow diagrams. Also, some of the components shown as being internal to the controller can also be stored external to the controller, and other components can be used.

The feature recommendation controller 302 may receive a training data set X_{q},Xₚ associated with contextual features and advertisement features. As described in further detail below, the feature recommendation controller 302, through implementation of a factorization machine, may use the training data set X_{q},Xₚ to generate a set of arms Π. The set of arms (or arms set) Π may include an m-number of arms π, with each arm π including a feature combination of one or more contextual features and an advertisement feature. The one or more contextual features may include a publisher feature, a user feature, or a combination of the two. A feature combination that includes the three different types of features may be referred to as a three-gram feature tuple. In addition or alternatively, a feature combination may indicate and/or be representative of a strategy of how to respond to a bid, i.e., whether to bid on or ignore an incoming ad request and/or how high or low of an amount with which to place the bid. The m-number of arms π included in the arms set Π may be a subset of a total number of arms (i.e., a total number of the different feature combinations) that may be derived from the training data set. Those m-number of arms may be included in the arms set Π due to being identified as having among the highest expected or predicted likelihoods of a response event and/or highest expected or predicted response rates. As denoted in FIG. 3, operation of the feature recommendation controller 302 of the system 300 may occur “offline,” meaning that it may be performed independent of and/or without being in response to received ad requests ADR.

The feature recommendation controller 302 may send or feed the arms set Π to the bidding controller 304. The feeding of the arms set π may be considered a parallel feeding of the m-number of arms it in the set π. In response to receiving the arms set Π, the bidding controller 304, using a multi-arm bandit system and Thompson sampling, may select an optimal one of the arms π that is determined to provide the highest expected reward (i.e., the highest likelihood of a response event) and/or correspond to the highest expected response rate. The bidding controller 304 may then compare the corresponding highest expected response rate with a threshold rate that represents a minimum threshold rate for a sufficient number of ad requests to satisfy a pacing rate. The bidding part may be performed “online” and receive incoming ad requests during real-time bidding. For a received incoming ad request, if the determined corresponding highest expected response rate exceeds the threshold, then the bidding controller 304 may determine to submit a bid (BID) and send the bid over the network 120 to the exchange auction server 112 (FIG. 1). Alternatively, if the highest expected response rate does not exceed the threshold, then the bidding controller 304 may determine not to submit a bid, and simply drop the ad request.

The controllers 302, 304 may take the form of processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. The controllers 302, 304 may be configured with hardware, software and/or firmware to perform the various functions described below and shown in the flow diagrams.

The feature recommendation controller 302 may provide a new or updated arms set Π to the bidding controller 304 multiple times and/or over different time periods or time intervals, such as predetermined time intervals. For example, the feature recommendation controller 302 may provide a new or updated arms set Π to the bidding controller 304 every thirty minutes, every hour, or every 24 hours, as non-limiting examples. In addition or alternatively, the feature recommendation controller 302 may provide a new or updated arms set Π upon a receipt of an input, such as a user input of the feature recommendation and bidding system 300, and/or a request from the bidding controller 304 indicating that the bidding controller 304 would like a new or updated arms set Π. Also, the m-number of arms π in the arms set Π may be a fixed number of may vary for the different arms sets Π that the feature recommendation controller 302 provides to the bidding controller 304. For example, in the latter configuration, one arm set Π may include 10 arms π, and the next arms set Π may include 12 arms or 25 arms. Various configurations for the different ways that the feature recommendation controller 302 provides arms sets Π to the bidding controller 304 may be possible.

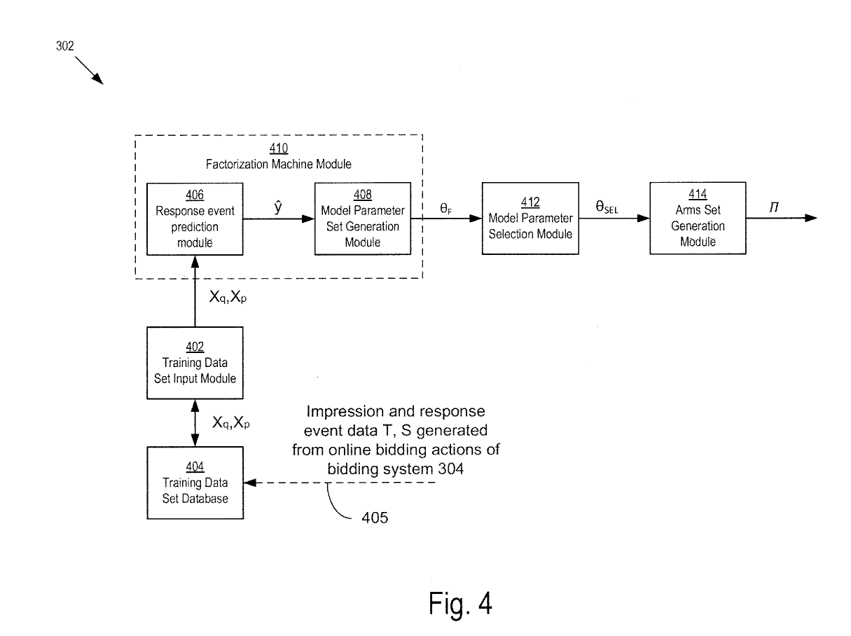

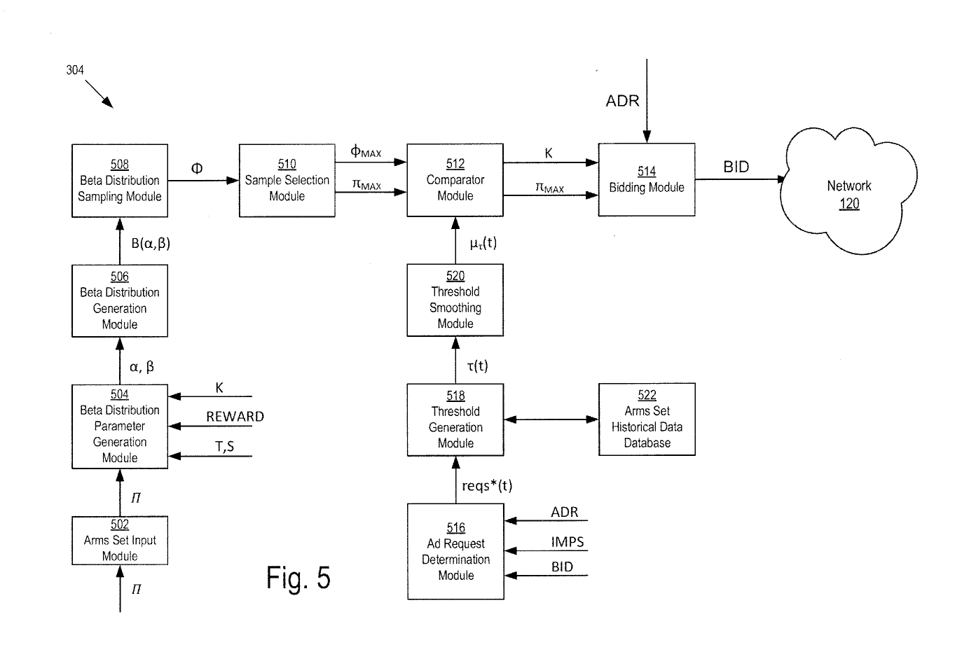

FIGS. 4 and 5 show block diagrams of example configurations of the feature recommendation controller 302 and the bidding controller 304 in further detail, respectively. Each of the feature recommendation controller 302 and the bidding controller 304 may include a plurality of modules. As used herein, a module may be hardware or a combination of hardware and software. For example, each module may include an application specific integrated circuit (ASIC), a field programmable gate array (FPGA), a circuit or circuitry, a digital logic circuit, an analog circuit, a combination of discrete circuits, gates, or any other type of hardware or combination thereof. In addition or alternatively, each module may include memory hardware that comprises instructions executable with a processor or processor circuitry to implement one or more of the features of the module. When any one of the module includes the portion of the memory that comprises instructions executable with the processor, the module may or may not include the processor. In some examples, each module may just be the portion of the memory or other non-transitory computer readable medium that comprises instructions executable with or by the processor to implement the features of the corresponding module without the module including any other hardware. Because each module includes at least some hardware even when the included hardware comprises software, each module may be interchangeably referred to as a hardware module.

Referring to FIG. 4, the feature recommendation controller 302 may include a training data set input module 402 that may be configured to access a training data set X_{q},Xₚ associated with a q-number of contextual features and a p-number of advertisement features. The training data set X_{q},Xₚ may be stored in a training data set database 404, which may be accessed by the training data set input module 402. In general, the training data set may include historical data that indicates user online behavior or interaction, and may be complied from one or more of a variety of different sources. In one example, the training data set X_{q},Xₚ may include data generated from impression and response event data indicating a number of impressions T and a number of response events (i.e., successes) S generated from the impressions T. The impression and response event data may be generated from advertisements associated with a different advertisement campaign, from advertisements associated with the campaign for which the feature combinations or recommendations are being provided, or a combination thereof. For example, in a cold start situation, an advertisement campaign first starting up may not have impression and response event data T, S obtained from its own online bidding, and the impression and response event data T, S may be derived from other, such as similar, advertisement campaigns. However, as the bidding controller 304 performs bidding online and obtains impression and response event data T, S for the advertisement campaign, that data may be fed back to the training data set database 404 and become part of the training data set X_{q}, Xₚ for future or subsequent iterations of the offline feature recommendation process. This is shown in FIG. 4 with dotted arrow 405, showing that impression and response event data obtained from the online bidding actions of the bidding controller 304 may be input to the training data set 404 to become part of an updated training data set X_{q}, Xₚ. When a subsequent offline feature recommendation process is performed, the training data set input module 402 may access the updated training data set X_{q}, Xₚ from the training data set database 404.

Each of the impressions T and the response events S may be associated with a contextual feature (including a publisher feature and/or a user feature), and an advertisement feature. Each of the impressions T and the response events S may be separated into their respective feature components T_{q},Tₚ and S_{q},Sₚ, where T_{q} are the impressions associated with the q-number of contextual features irrespective of the advertisement features, Tₚ are the impressions associated with the p-number of advertisement features irrespective of the contextual features, S_{q} are the response events associated with the q-number of contextual features irrespective of the advertisement features, and Sₚ are the response events associated with the p-number of advertisement features irrespective of the contextual features. Under the assumption that each response event is a Bernoulli random variable, the maximum likelihood estimation of a response event given a feature (contextual or advertisement) can be estimated by the response rate X, which is the number of response events S per the number of impressions, or S/T. The training data set X_{q}, Xₚ may then be generated by separating the response rate X into its contextual and advertisement components. Mathematically, the training data set portion X_{q} associated with the contextual features may be a vector with data values set to S_{q}/T_{q}, and the training data set portion Xₚ associated with the advertisement features may be a vector with data set values set to Sₚ/Tₚ.

In one example configuration, the training data set X_{q},Xₚ may be stored in the training data set database 404, where they may be retrieved by the training data set input module 402. Upon retrieval, the training data set input module 402 may pass the training data set X_{q},Xₚ to a response event prediction module 406. Other configurations are possible. For example, the training data set may include the impression T and response event S information, and the training data set input module 402 or the response event prediction module 406 (or a different module in the feature recommendation controller 302) may generate the contextual and advertisement response rates X_{q},Xₚ for use by the response event prediction module 406.

In addition or alternatively, the training data set X_{q}, Xₚ may include data associated with and/or derived from sources other than impression and response event data. For example, the training data set X_{q}, Xₚ may include contextual and advertisement features associated with keywords or keyword searches. As another example, the training data set X_{q}, Xₚ may include contextual and advertisement features associated with email. Other sources used to derive the training data set X_{q}, Xₚ may be possible.

The response event prediction module 406, using the training data set X_{q},Xₚ and an initial iteration of a modeling parameter set θ^{t0}, the response event prediction module 406 may generate initial predicted response event values 9 for the different feature combinations associated with the training data set X_{q},Xₚ. Each of the predicted response event values ŷ may indicate a prediction of a response event given a combination of one or more contextual features (e.g., a publisher feature and a user feature) and an advertisement feature. After generating an initial set of predicted response event values ŷ, it may pass the initial set ŷ to a model parameter set generation module 408. In response, the model parameter set generation module 408 may generate a final model parameter set θ_{F}, which may be parameters that model the probability of a response event given a particular tuple of contextual and advertisement features.

The response event prediction module 406 and the model parameter set generation module 408 may be part of and/or implemented in accordance with a factorization machine 410. Accordingly, the response event prediction module 406 may implement the following formula to generate the initial predicted response event values ŷ:

$$\begin{matrix}\hat{y} = {w}_{0} + {\sum }_{i = 1}^{n} {w}_{i} {x}_{i , q} + {\sum }_{i = 1}^{n} {\sum }_{j = i + 1}^{n} {\hat{w}}_{i , j} {x}_{i , q} {x}_{j , p} , where & ( 2 ) \\ {\hat{w}}_{i , j} = 〈 {v}_{i} , {v}_{j} 〉 = {\sum }_{f = 1}^{k} {v}_{i , f} {v}_{j , f} , where & ( 3 ) \\ w = \{ {w}_{0} , {w}_{1} , … {w}_{n} \} ∈ {ℝ}^{n} , V = \{ {v}_{1} , … , {v}_{n} \} ∈ {ℝ}^{k \times n} & ( 4 )\end{matrix}$$

where
x_{i,q} is the ith training value in the contextual feature training vector X_{q}; x_{j,p} is the jth training value in the advertisement feature training vector Xₚ; n is the total number of features (contextual and advertisement); k is a hyperparameter that defines the dimensionality of the factorization, [symbol] vᵢ, vⱼ [symbol] is the dot product of the ith vector vᵢ and the jth vector vⱼ of the matrix V, where w is a modeling vector, V is a modeling matrix, and where the modeling vector w and the modeling parameter matrix V form a modeling parameter set θ that includes a plurality of modeling parameters (also or interchangeably referred to as modeling parameter vectors), such that θ {θ₁, . . . , θ_{k×n+n+1}}={w, V}. As used herein, individual modeling parameters in the modeling parameter set θ may be referred to as an ith modeling parameter or simply as a modeling parameter θᵢ.

Values for the initial iteration of the modeling parameter set θ^{t0} may be set according to a normal distribution η with a mean π set to zero, and a variance σ² set to the standard deviation σ (i.e., η(0, σ)). The initial iteration of the modeling parameter set θ^{t0} may be broken into an initial modeling vector w and an initial modeling matrix V. The response event prediction module 406 may then generate an initial set of predicted response event values ŷ using equation (2) above with the training data set X_{q},Xₚ and the initial modeling vector w and initial modeling matrix V as the inputs values. The response event prediction module 406 may then pass the initial set of predicted response event values ŷ to the model parameter set generation module 408.

The model parameter set generation module 408 may be configured to iteratively update the modeling parameter set θ until a certain criterion is satisfied, at which point the current iteration of the modeling parameter set θ may be a final iteration of the set of modeling parameters θ_{F}. In a particular implementation, the model parameter set generation module 408 may iteratively update the model parameter set θ according to stochastic gradient descent (SGD). Mathematically, the model parameter set generation module 408 may iteratively update the modeling parameter set according to the following formula:

$${θ}_{i}^{t + 1} = {θ}_{i}^{t} - η ( \frac{\partial }{\partial {θ}_{i}^{t}} l ( y ( x ) , y ) + 2 λ {θ}_{i}^{t} ) \qquad ( 5 )$$

where θᵢ^{t} is the current iteration of the ith modeling parameter in the current iteration of the modeling parameter set θ^{t}; θᵢ^{t+1} is the next iteration of the ith modeling parameter vector in the next iteration of the modeling parameter set θ^{t+1}; η is a learning rate value; λ is a regularization value; y denotes a ground truth label (i.e., actual response event information) of the training data set X_{q},Xₚ,/(ŷ,y) denotes a loss function between the initial set of predicted response event values ŷ and the ground truth label y (i.e., with the initial set of predicted response event values ŷ and the ground truth label y being the inputs to the loss function l). Accordingly, as shown in equation (5), for each current iteration of the ith modeling parameter θᵢ^{t} in the current iteration of the modeling parameter set θ^{t}, a derivative with respect to the current iteration of the ith modeling parameter θᵢ^{t} of the loss function l is determined.

After the next iteration of the ith modeling parameter θᵢ^{t+1} is determined, that next iteration becomes the current iteration of the ith modeling parameter θᵢ^{t}, and the calculation is repeated. The model parameter set generation module 408 may repeat the calculation until it determines that a convergence criterion associated with the SGD equation (5) is satisfied. In some example configurations, the convergence criterion may be satisfied when the gradient in equation (5) is zero or sufficiently close to zero (i.e., within a predetermined range of zero). In other example configurations, the convergence criterion may be satisfied when a predetermined number of iterations is performed. A combination of the two examples is also possible—i.e., the convergence criterion is satisfied when the gradient is zero or sufficiently close to zero or the predetermined number of iterations is performed, whichever comes first. Other ways of determining that the convergence criterion is satisfied may be possible. When the model parameter set generation module 408 determines that the convergence criterion is satisfied, it may set at that point in the iteration process the current iteration of the modeling parameter set θ^{t} as the final modeling parameter set θ_{F}. The model parameter set generation module 408 may then output the final modeling parameter set θ_{F} to a model parameter selection module 412.

Each of the ith modeling parameters θᵢ in the final modeling parameter set θ_{F} may be associated with a certain feature combination of contextual and advertisement features. In addition, values of each ith modeling parameter θᵢ in the final modeling parameter set θ_{F} may indicate a response likelihood ranking, where the higher the response likelihood ranking, the greater the likelihood that the feature combination associated with that ith modeling parameter θᵢ may yield a response event. The model parameter selection module 412 may be configured to select, among the modeling parameter vectors in the final modeling parameter set θ_{F}, an m-number of modeling parameters that have the m-number of highest response likelihood rankings in the final set θ_{F}. Relatively, the number m is much smaller than the total number of modeling parameters in the final set θ_{F}. The model parameter selection module 412 may group or consolidate the m-number of modeling parameters with the highest response likelihood rankings into a selected model parameter set θ_{SEL}. The model parameter selection module 412 may then send the selected model parameter set θ_{SEL} to an arm set generation module 414.

Each of the selected model parameters in the selected model parameter set θ_{SEL} may correspond to a feature combination of contextual and advertisement features, such as a three-gram feature tuple for example. These m-number of feature combinations corresponding to the m-number of selected model parameters may represent the m-number of feature combinations with the highest predicted likelihoods of yielding a response event among the different feature combinations associated with the training data set X_{q},Xₚ. In response to receiving the selected model parameter set θ_{SEL}, the arm set generation module 414 may determine the corresponding m-number of feature combinations that correspond to the m-number of selected model parameters, and set each feature combination as one of an m-number of arms π. The m-number of arms π may make up an arms set Π, such that Π={π₁, . . . πₘ}. The arms set Π may also be referred to as a feature recommendation set, with each arm πᵢ in the set Π being a feature recommendation that the bidding controller 304 may consider when performing bidding decisions. After the arm set generation module 414 generates the arms set Π, it may send the arms set Π to bidding controller 304. Sending the arms set Π may be synonymous with sending the m-number of arms π in parallel.

As previously described, the bidding controller 304 may be performed online and make bidding decisions for received ad requests ADR. Each qth ad request ADR_{q} may be associated with a set of contextual features, including one or more publisher features and one or more user features. The set of contextual features may be represented by a qth contextual feature vector I_{q}. Each time the bidding controller 304 receives an ad request ADR_{q} and makes a bidding decision on that ad request ADR_{q} may be referred to as a round q. At each round q (i.e., for each received ad request ADR_{q}), the bidding controller 304 may make a decision to select one of the arms πᵢ in the arms set Π given the contextual feature vector I_{q} associated with the received ad request ADR_{q} that will yield the highest expected likelihood of a response event such that a cumulative reward for a plurality of received ad requests ADR may be maximized. As described in further detail below, the bidding controller 304 may implement Thompson sampling to select the arms π.

Referring to FIG. 5, the bidding controller 304 may include an arms set input module 502 that may be configured to receive the arms set Π from the arms set generation module 414. Thompson sampling may be employed using a beta distribution parameter generation module 504, a beta distribution generation module 506, a beta distribution sampling module 508, and a sample selection module 510. Upon receipt of the arms set Π, the arms set input module 502 may pass the arms set Π to the beta distribution parameter generation module 504. The beta distribution parameter generation module 504 may be configured to generate an alpha parameter αᵢ and a beta parameter βᵢ pair for each arm πᵢ (hereafter referred to as an alpha-beta parameter pair αᵢ,βᵢ) in the arms set Π. The plurality or m-number of alpha-beta pairs α,β corresponding to the m0number of arms π in the arms set Π may be referred to as an alpha-beta pair set. After the beta distribution parameter generation module 504 generates the m-number of alpha-beta pairs α,β, it may send the set to the beta distribution generation module 506.

The beta distribution generation module 506 may be configured to generate a plurality or m-number of beta distributions B(α,β), with each beta distribution Bᵢ(αᵢ,βᵢ) corresponding to an arm πᵢ. Each beta distribution Bᵢ(αᵢ, βᵢ) may be generated based on its associated alpha beta parameter pair αᵢ,βᵢ. The plurality of beta distributions B(α,β) corresponding to the arms π in the arms set Π may be referred to as a beta distribution set. After the beta distribution generation module 506 generates the beta distribution set B(α,β), it may send the set to the beta distribution sampling module 508. The beta distribution sampling module 508 may be configured to sample each beta distribution Bᵢ(αᵢ, βᵢ) to generate a plurality or m-number of beta distribution samples φ. The plurality of beta distribution samples φ may be referred to as a beta distribution sample set. After the beta distribution sampling module 508 generates the beta distribution samples φ, it may send the sample set φ to the sample selection module 510. In response to receiving the beta distribution sample set φ, the sample selection module 510 may select a maximum beta distribution sample φ_{MAX} of the distribution samples φ, which may correspond to an arm πᵢ (or feature combination) that indicates the highest expected likelihood or probability of a response event and/or the highest expected response rate (e.g., click-through-rate (CTR) or conversion rate (also referred to as action rate (AR)).

After the sample selection module 510 selects the maximum beta distribution sample φ_{MAX}, it may send the maximum sample φ_{MAX} to a comparator module 512. The comparator module 512 may be configured to compare the maximum beta distribution sample φ_{MAX} with a threshold μ_{τ}(t). Based on the comparison, the comparator module 512 may generate a bidding decision K and send the bidding decision to a bidding decision module 514. In particular, if the maximum sample φ_{MAX} is greater than the threshold μ_{τ}(t), then the comparator module 512 may set the bidding decision K to indicate to the bidding decision module 514 to bid on a received ad request ADR_{q}. Alternatively, if the maximum sample φ_{MAX} is less than the threshold μ_{τ}(t), then the comparator module 512 may set the bidding decision K to indicate to the bidding decision module 514 to not bid on or ignore the received ad request ADR_{q}.

A comparison of the maximum beta distribution φ_{MAX} and the threshold μ_{τ}(t) may be performed in order to take into consideration the budget constraint of the campaign for which advertisements are being bid on, in accordance with equation (1) above. In general, it may be desirable for the bidding decision module 514 to bid on ad requests according to a pacing rate for a given time slot t. As used herein for the calculation of the threshold μ_{τ}(t), a time slot may be a time period during which an ad request for a unique impression (i.e., an impression associated with a unique set of publisher, user, and advertisers features) is received and/or bid on. A pacing rate in a time slot t may be the number of bids made per the number of ad requests received during the time slot slot t. If the bidding decision module 514 bids faster than the pacing rate, then the bidding decision module 514 may spend the budget allocated for the time slot t before the time slot t ends. Alternatively, if the bidding decision module 514 bids slower than the pacing rate, then the bidding decision module 514 may not spend all of the allocated budge before the end of the of the time slot t.

The threshold μ_{τ}(t) may correspond to a minimum expected response rate that satisfies a pacing rate for the time slot t. As mentioned, the maximum beta distribution sample φ_{MAX} may correspond to a maximum expected response rate provided by the arms π. As such, if the maximum sample φ_{MAX} provides a response rate that is greater than a minimum response rate that satisfies the pacing rate, then the comparator module 512 may instruct the bidding decision module 514 to place a bid for an coming request ADR since doing so may optimize the expected cumulative reward given the pacing rate. Alternatively, if the maximum sample φ_{MAX} provides a response rate that is less than the minimum response rate that satisfies the pacing rate, then the comparator module 512 may instruct the bidding decision module 514 to forego placing a bid on the incoming ad request ADR since otherwise bidding will result in a less than optimal cumulative reward given the pacing rate. The determination of the threshold μ_{τ}(t) is described in further detail below.

As shown in FIG. 5, the bidding decision module 514 may be configured to receive ad requests ADR and determine whether to bid or not bid on each of the requests ADR based on bidding decisions K received from the comparator module 512. If a bidding decision K indicates to bid on an ad request ADR_{q}, the bidding decision module 514 may generate an associated bid BID_{q} and send the associated bid BID_{q} over the network 122 the exchange auction server 112 (FIG. 1). The bid BID_{q} may include a bid amount. The bid BID_{q} may also include information about the advertisement it wants to be displayed in the impression for which the bidding decision module 514 is bidding. The advertisement information may include a set of advertisement features, which may be represented by an optimal advertisement feature vector A_{MAX} that may be associated with and/or a part of an optimal arm π_{MAX} that corresponds to the maximum beta distribution sample φ_{MAX}. FIG. 5 shows the sample selection module 510 sending the optimal arm π_{MAX} to the comparator module 512, which in turn may pass the optimal arm π_{MAX} to the bidding decision module 514 so that the bidding decision module 514 can include the advertisement features associated with the optimal arm π_{MAX} (i.e., A_{MAX}) with the bid BID_{q}. Other ways of communicating the optimal advertisement feature vector A_{MAX} or otherwise indicating the advertisement to be displayed should the bid win may be possible.

The beta distribution parameters α,β generated by the beta distribution parameter generation module 504 may be updated on a round by round basis. In particular, the beta distribution parameters may be updated according to the following formulas:

αᵢ^{t}=αᵢ⁰+rᵢ^{t} (6)

βᵢ^{t}=βᵢ⁰+nᵢ^{t}−rᵢ^{t} (7)

where αᵢ^{t} is the ith alpha parameter corresponding to the ith arm πᵢ in a current time slot t, βᵢ^{t} is the ith beta parameter corresponding to the ith arm πᵢ in a current time slot t, αᵢ⁰ is an ith initial alpha parameter value, βᵢ⁰ is an ith initial beta parameter value, rᵢ^{t} is the ith cumulative reward count associated with the ith arm πᵢ in a current time slot t, and nᵢ^{t} is the ith cumulative play count associated with the ith arm πᵢ in a current time slot t. Each of the cumulative reward counts r and cumulative play counts may be initialized to zero. An ith play count nᵢ^{t} associated with an ith arm πᵢ may be incremented each time an ith beta distribution sample φᵢ is selected by the sample selection module 510 as being the maximum sample φ_{MAX} (i.e., each time the associated ith arm πᵢ is played). An ith reward count rᵢ^{t} may incremented each time a response event associated with the playing of the ith arm πᵢ occurs.

As an illustration, suppose m is twenty-five, meaning that there are twenty-five arms π₁ to π₂₅ in an arms set Π (i.e., Π={π₁ . . . π₂₅}). Suppose, a first ad request ADR₁ is received, and a fifth beta distribution sample φ₅ associated with a fifth arm π₅ is chosen as the maximum sample φ_{MAX}. Suppose then that the fifth beta distribution sample φ₅ is greater than the threshold μ_{τ}(t), resulting in a bid BID₁ being submitted (i.e., the fifth arm π₅ being played). As a result, the fifth cumulative play count n₅^{t} may be incremented by one. Further, suppose the bid BID₁ is won and subsequently a response event (i.e., a reward) is observed. The fifth cumulative reward count r₅^{t} may be incremented by one. All of the other cumulative play counts n and cumulative reward counts r may not be incremented.

The beta distribution parameter generation module 504 may be configured to keep track of and continually update each of the cumulative play counts n and cumulative reward counts r as new ad requests ADR are received and bids are made. As shown in FIG. 5, the beta distribution parameter generation module 504 may be configured to receive the bidding decisions K in order to update the cumulative play counts n and observed reward information REWARD in order to update the cumulative reward counts r. By updating the cumulative play counts n and the cumulative reward counts r, the beta distribution parameter generation module 504 may continuously update the alpha and beta parameters α,β as bids are submitted and rewards are observed.

As indicated above, the alpha and beta parameters α, β may be indexed according to the arms with which they are associated as well as time slots. In a single time slot, a single ad request may be received or a plurality of ad request may be received. If multiple ad requests are received in a single time slot, then in some example configurations, the beta distribution parameter module 504 may be configured to increment the cumulative play counts n and the cumulative reward counts r continuously and correspondingly update the alpha and beta parameters α, β in that time slot as ad requests are received, arms are played (i.e., bids are submitted) and rewards are observed. In other configurations, if multiple ad requests are received within a single time slot, the beta distribution parameter module 504 may keep track of the plays and rewards, but the actual cumulative play counts n and the actual cumulative reward counts r, and/or the alpha and beta parameters α, β may not be updated until the end of the time slot. In addition, the values for the cumulative play counts n and the cumulative reward counts r and the alpha and beta parameters α, β may be updated and/or accumulated over multiple time slots t, t+1, t+2, and so on, as opposed to being reset at the beginning of each time slot.

In addition, as mentioned, the cumulative play counts n and the cumulative reward counts r may be initialized to zero As such, the ith alpha and beta parameters αᵢ^{t},βᵢ^{t} may be initially set to the initial ith alpha and beta values αᵢ⁰, βᵢ⁰, respectively. As previously described, the training data set X_{q},Xₚ used by the feature recommendation controller 302 to generate the arms π in the arms set Π may be based on or derived from one or more of a variety of different sources, including impression and response event data and/or other “non” impression and response event data, such as search keywords or email as examples. Where the arms set Π is generated based on impression and response event data, each of the ith initial alpha values αᵢ⁰ may be set to the number of ith response events (i.e., successes) Sᵢ corresponding to the ith arm πᵢ in the arms set Π, and each the ith initial beta value βᵢ⁰ may be set to the number of ith impressions Tᵢ less the number of ith successes Sᵢ corresponding to the ith arm πᵢ in the arms set Π (i.e., Tᵢ minus Sᵢ) as indicated in the training data set. Alternatively, where the arms set Π is generated based on “non” impression and response event data, such as keywords or email, each of the ith initial alpha and beta values αᵢ⁰, βᵢ⁰ may be set to default or global initial values. An advertising hierarchical taxonomy structure may be applied to determine the initial alpha and beta values α⁰, β⁰ as necessary.

As previously described, the threshold μ_{τ}(t) may correspond to a minimum expected response rate that satisfies a pacing rate for a time slot t. The threshold μ_{τ}(t) may be generated using an ad request determination module 516, a threshold generation module 518, and a threshold smoothing module 520. As a brief summary of these modules, the ad request determination module 516 may be configured to generate an ad request value for a current time slot t reqs*(t), which may indicate a number of ad requests to be received with the current time slot t in order for a spend budget for that time slot t to be achieved given a determined pacing rate. The ad request determination module 516 may send the ad request value reqs*(t) to the threshold generation module 518, which may generate an initial threshold τ(t) based on the ad request value reqs*(t). The threshold generation module 518 may send the initial threshold τ(t) to the threshold smoothing module 520. Based on the initial threshold τ(t), the threshold smoothing module 520 may generate the threshold μ_{τ}(t) and send the threshold μ_{τ}(t) to the comparator module 512 for a comparison.

In further detail, in a current time slot t, the amount of money spent for acquiring inventory may be proportional to the number of impressions served during the current time slot t. Based on this proportionality, the pacing rate may be the portion of incoming ad requests ADR that a campaign would like to have bid on during the time slot t. As such, the relationship between a pacing rate and a current budget to be spent in a time slot t may be expressed by the following formulas:

$$\begin{matrix}s ( t ) = {\sum }_{q ∈ {𝕁}_{t}} {c}_{q} {A}_{q} ∝ imps ( t ) & ( 8.1 ) \\ ∝ reqs ( t ) \frac{bids ( t )}{reqs ( t )} \frac{imps ( t )}{bids ( t )} & ( 8.2 ) \\ ∝ req ( t ) \cdot pacing\_rate ( t ) \cdot win\_rate ( t ) & ( 8.3 )\end{matrix}$$

where with reference to equation (8.1), s(t) is the dollar amount spent within a current time slot t, c_{q} is the inventory cost for a qth ad request ADR_{q} once an associated qth impression is served, [symbol] ₜ represents the index set of all ad requests ADR that are received in the current time slot t, A_{q} represents the qth advertisement feature vector associated with the qth ad that may be displayed when the qth impression is served, and imps(t) is the total number of impressions of the campaign (i.e., total number of bids that are won in auction) during the current time slot t. In addition, with reference to equations (8.2) and (8.3), reqs(t) is the number of incoming ad requests that satisfy audience targeting constraints of a campaign in a current time slot t, bids(t) is the number of ad requests that the bidding decision module 514 has bid on in the current time slot t, pacing_rate(t) rate is the pacing rate under which bids are to be made during the current time slot t, and win_rate(t) is the winning rate at which the bids are won in the auction. Accordingly, from equation (8.3), in a current time slot t, the amount of money to be spent may be proportional to the number of incoming ad requests that satisfy audience targeting constraints multiplied by bids made and further multiplied by the winning rate at which the bids are being won.

In determining the ad request value reqs*(t), logically, for a current time slot t, a budget or desired spend amount b(t) may be set to the dollar amount spent s(t) in the current time slot t. Also, the budget b(t) may be equal to (as opposed to just proportional to) the product of the number of incoming ad requests reqs(t), the total number of impressions of the campaign imps(t), and the winning rate win_rate(t) when a cost per thousand (CPM) constant billing_cpm is included in the product. The CPM constant may be an amount that an advertiser pays for every 1,000 impressions associated with an ad in its campaign. This amount may be constant or fixed among time slots during the course of the online bidding for a campaign. Also, the CPM constant billing_cpm may be a negotiated and agreed upon amount determined between the advertiser and the operator of the feature recommendation and bidding system 300 and/or the ad server 106 implementing the feature recommendation and bidding system 300. The ad request value reqs*(t) for a current time slot t may be determined according to the following equation:

$${reqs}^{*} ( t ) = \frac{b ( t )}{billing\_cpm \cdot pacing\_rate ( t ) \cdot win\_rate ( t )} \qquad ( 8.4 )$$

Feedback information from the current time slot t may be used to determine the pacing rate for the next time slot t+1. In particular, by considering the ratios of the pacing rate, the dollar amount spent, the number of incoming ad requests, the number of bids, and the bid winning rate between the current time slot t and the next time slot t+1, the pacing rate for the next time slot t+1 may be determined by the following formulas:

$$\begin{matrix}pacing\_rate ( t + 1 ) = pacing\_rate ( t ) \frac{s ( t + 1 )}{s ( t )} \frac{reqs ( t )}{reqs ( t + 1 )} ( 9.1 ) \\ \frac{win\_rate ( t )}{win\_rate ( t + 1 )} \\ = pacing\_rate ( t ) \frac{b ( t + 1 )}{s ( t )} \frac{reqs ( t )}{reqs ( t + 1 )} ( 9.2 ) \\ \frac{win\_rate ( t )}{win\_rate ( t + 1 )}\end{matrix}$$

where reqs(t+1) and win_rate(t+1) represent a predicted number of ad requests and a predicted winning rate for the bids, respectively, in the next time slot t+1. The predictions may be set according to historical data that considers the ratios of the parameters, not necessarily their absolute values. Additionally, in equation (9.2), the term b(t+1) represents an ideal desired spend amount for the next time slot t+1. Different choices for the ideal desired spend amount may introduce different strategies for budget pacing. As shown in FIG. 5, the ad request determination module 516 may receive information about the received ad requests ADR, bid information BID, and impression (bids won) information IMPS in order to calculate the pacing rate for the next time slot pacing_rate(t+1) in accordance with equations (9.1), and (9.2). Then, when the next time slot t+1 becomes the current slot t, the pacing rate for the next time slot pacing_rate(t+1) may be set to the pacing rate for the current time slot pacing_rate(t) and used in equation (8.4) to determine the ad request value reqs*(t) for a current time slot t.

After the ad request determination module 516 generates the ad request value reqs*(t) for the current time slot t, it may send the ad request value reqs*(t) to the threshold generation module 518. The threshold generation module 518 may determine a minimum response rate that satisfies the pacing rate corresponding to the ad request value reqs*(t). To do so, the threshold generation module 518 may access an arms set historical data database 522 that includes historical data about the arms π. In particular, the data may include the number of ad requests ADR that have been received for that arms set Π (i.e., the number of ad requests ADR received during the time that the arms set Π have been the arms available for selection). The historical data may also include response rate information as a function of the number of received ad requests ADR. Using the historical data, the threshold generation module 518 may be configured to generate a distribution of the number of ad requests received as a function of response rate. In other example configurations, the historical data may already include the distribution information.

Using the distribution, the threshold generation module 518 may be configured to determine a minimum response rate that provides a minimum expected response rate that satisfies a pacing rate for the current time slot t using the accessed distribution. In particular, the threshold generation module 518 may determine a response rate x such that integrating from the determined response rate x to 1 over the distribution yields a number of ad requests that is closest to the ad request value reqs*(t). That determined response rate x may be set to the initial threshold τ(t). Mathematically, the threshold generation module 518 may determine the initial threshold τ(t) according to the following formula:

$$τ ( t ) = arg {min}_{x} \vert {\int }_{x}^{1} {q}_{t} ( s ) d s - {reqs}^{*} ( t ) \vert \qquad ( 10 )$$

where s is the response rate variable and qₜ(s) is the distribution as a function of response rate.

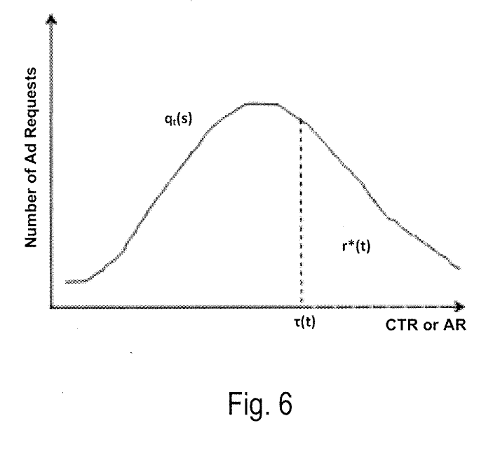

FIG. 6 shows a graphical representation of an example distribution qₜ(s) of a number of incoming ad requests associated with an arm set Π as a function of response rate (click through rate (CTR) or action rate (AR)) that may be generated from and/or stored as data in the arms set historical data database 522. Integrating from a response rate τ(t) to 1 along the distribution qₜ(s) may yield a total number of ad requests having associated response rates greater than the response rate τ(t), where the total number resulting from τ(t) is closer to the ad request value reqs*(t) than any other ad request numbers resulting from any other response rate value chosen along the x-axis of the distribution graph. In addition, as indicated in FIG. 6, integrating from τ(t) to 1 may yield a cumulative reward r*(t) associated with that total number of ad requests.

Referring back to FIG. 5, to avoid situations where the threshold used by the comparator module 512 changes rapidly from time slot to time slot, the initial threshold τ(t) may sent to the threshold smoothing module 520, which may generate the threshold μ_{τ}(t) through an adaptive update process, where the threshold μ_{τ}(t) is based on the initial threshold τ(t) and the threshold from the prior time slot μ_{τ}(t−1). In particular, the threshold smoothing module may generate the threshold μ_{τ}(t) using the following mathematical formula:

$$\begin{matrix}{μ}_{τ} ( t ) = \frac{( T - 1 ) {μ}_{τ} ( t - 1 ) + τ ( t )}{T} , or & ( 11.1 ) \\ {μ}_{τ} ( t - 1 ) + \frac{1}{T} ( τ ( t ) - {μ}_{τ} ( t - 1 ) ) & ( 11.2 )\end{matrix}$$

where t denotes the current time slot, (t−1) denotes the prior time slot, T denotes the total number of time slots including the current time slot t, and (T−1) denotes the total number of prior time slots excluding the current time slot t. Equations 11.1 and 11.2 are equivalent to one another, although equation 11.1 makes more apparent that the threshold μ_{τ}(t) of the current time slot t is based on a weighted average of the initial threshold τ(t) of the current time slot t and the threshold μ_{τ}(t−1) of the prior time slot (t−1). Since the threshold μ_{τ} is based on prior thresholds (i.e., thresholds determined from prior time slots), then μ_{τ}(t−1) is based on an averaging of all of the prior time slots. As such, the weighted averaging performed in equations 11.1 and 11.2 more heavily weights μ_{τ}(t−1) over τ(t) in proportion to the number of prior time slots, resulting in a threshold μ_{τ} that changes smoothly or gradually or several time slots. After the threshold smoothing module 520 generates the threshold μ_{τ}(t), it may send the threshold μ_{τ}(t) to comparator module 512 for a comparison.

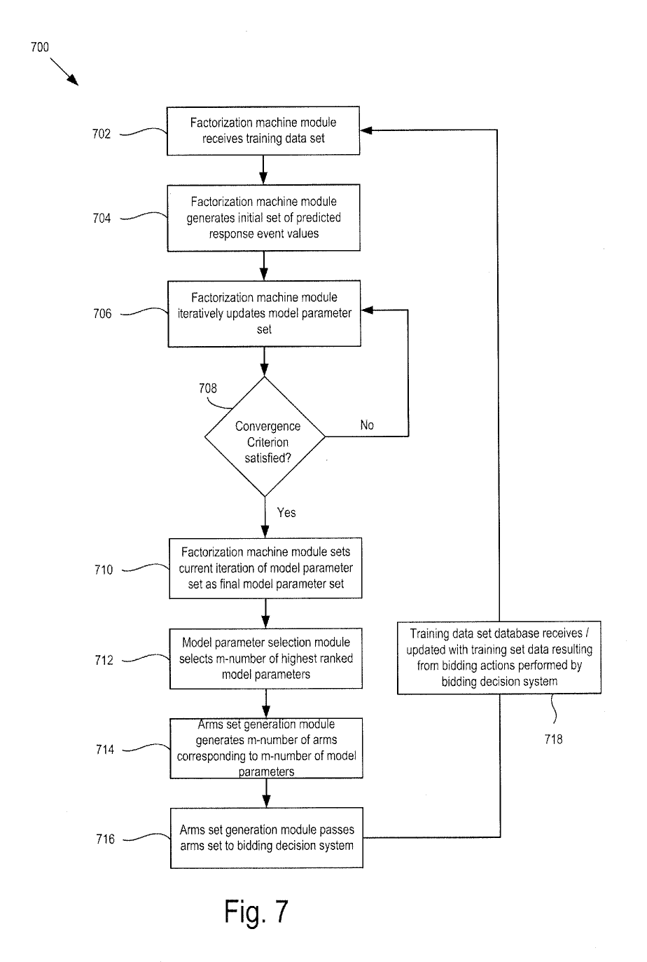

FIG. 7 shows a flow chart of an example method 700 of generating a plurality of feature recommendations for a bidding decision module. At block 702, factorization machine module may receive a training data set. The training data set may include response rate information separated into its advertisement and contextual feature components and/or non-response rate information, such as contextual and/or advertisement feature information associated with keywords and/or email. In some examples of method 700, the factorization machine module receive the training data set via an input module that may access a training data set database to obtain the training data set. At block 704, in response to receiving the training data set, the factorization machine module may generate an initial set of predicted response event values, which may identify predicted response events for the various combinations of contextual and advertisement features associated with the training data set. The factorization machine module may do so using equation (2) above. At block 706, starting with the initial set of predicted response event values and an initial model parameter set models the contextual and advertisement features and response events associated with the training data set, the factorization machine module may iteratively update the model parameter set until a convergence criterion is satisfied. The factorization machine module may iteratively update the model parameter set using stochastic gradient descent according to equation (5) above.

At block 708, if the convergence criterion is not satisfied, then the method 700 may proceed back to block 706 where the model parameter set is continued to be iteratively updated. Alternatively, at block 708, if the convergence criterion is satisfied, then at block 710, the factorization machine module may set the current iteration of the model parameter set as a final model parameter set and pass the final model parameter set to a model parameter selection module. At block 712, the model parameter selection module may select an m-number of model parameters having an m-number of highest rankings response likelihood rankings. At block 714, an arms set generation module may identify an m-number of feature combinations corresponding to the m-number of model parameters, and set the m-number of feature combinations as an m-number of arms of an arms set. At block 716, the arms set generation module may pass the arms set to a bidding decision system as a set of feature combination recommendations.

In some examples, the method 700 may end with the arms set being passed to the bidding decision system. In other examples, the method 700 may proceed to block 718, where the training data set may be updated with new response rate information that may be generated based on bidding performed by the bidding decision system. For these examples, the method may proceed back to block 702, where the factorization machine module receives training data set, this time as an updated training data set. The method 700 may then repeat to provide an updated arms set to the bidding decision system as a set of feature combination recommendations. In some examples, the method 700 may be repeated several times or at predetermined time intervals, such as once every hour, six hours, or 24 hours as non-limiting examples. Also, in some examples, method 700 may be repeated without the training data set necessarily being updated.

The example method 700 may be implemented for an advertisement campaign, including a new advertisement campaign having one or more advertisements for which the bidding decision system is bidding on ad requests. The example method 700 may be performed offline, as previously explained. In addition or alternatively, the example method 700 may be implemented in a cold start situation and/or to address the cold start problem for the advertisement campaign. In some examples, the training data set that the factorization machine module receives may not include any response rate information for the

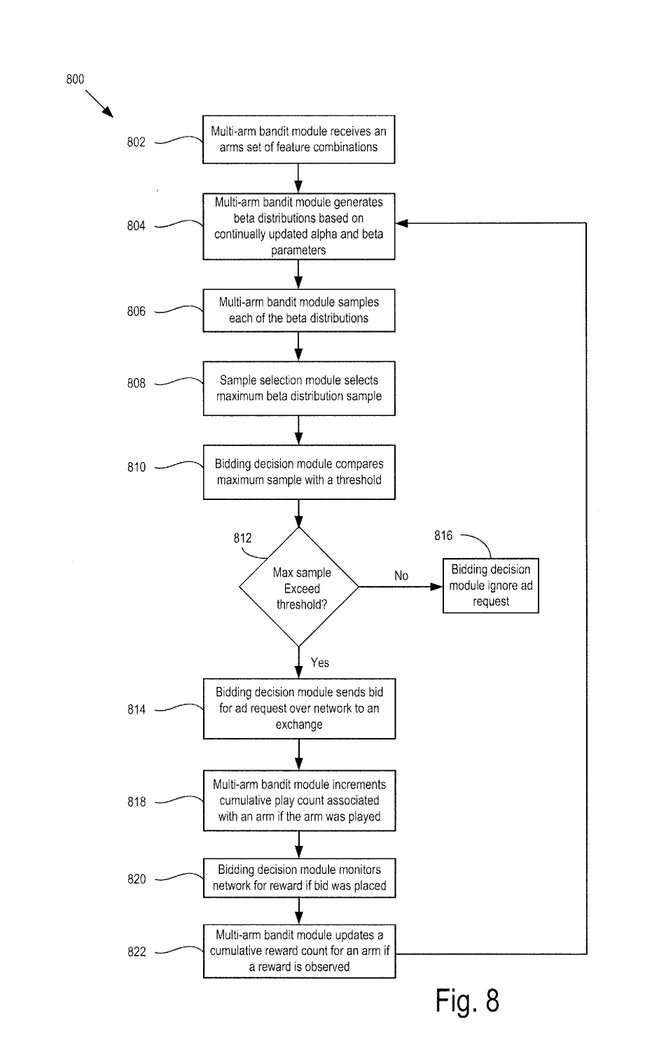

FIG. 8 shows a flow chart of an example method 800 of performing bidding decisions for incoming ad requests from over a network. At block 802, a multi-arm bandit module may receive an arms set including a plurality of arms. Each arm in the set may include and/or indicate a feature combination of contextual and advertisement features. At block 804, the multi-arm bandit module may generate beta distributions for each of the arms in the arm set. The beta distributions may be generated based on associated alpha and beta parameters. The multi-arm bandit module may determine the alpha and beta parameters using cumulative play and reward counts that are based on prior arm selection and reward information, and/or according to equations (6) and (7) above. At block 806, the multi-arm bandit module may sample each of the beta distributions to generate a set of beta distribution samples. At block 808, a sample selection module may select the maximum beta distribution sample, which may indicate and/or correspond to a highest likelihood of a response event and/or a response rate.

At block 810, a bidding decision module may compare the maximum beta distribution sample with a threshold indicating an optimal response rate for a pacing rate for a time slot. The optimal response rate may be a response rate that yields a number of ad requests that is closest to the number of ad requests to be received for the pacing rate to be maintained. At block 812, if the maximum beta distribution sample is greater than the threshold, then at block 814, then the bidding decision module may send a bid for a current ad request over the network to an exchange server. Advertisement features associated with the bid may be those that are associated with the arm corresponding to the maximum beta distribution sample. Alternatively, at block 812, if the maximum beta distribution sample is less than the threshold, then at block 816, the comparator module may ignore the ad request.

At block 818, for a received ad request, the multi-arm bandit module may increment a cumulative play count associated with an arm if the arm was played (i.e., the arm is associated with the maximum distribution sample and the maximum distribution exceeded the threshold such that a bid on the received ad request was placed). At block 820, if a bid was placed, the network may be monitored or observed for a reward (i.e., a response event). At block 822, the multi-arm bandit module may update a cumulative reward count for an arm if a response event is observed. The method 800 may then proceed back to block 804, where beta distributions for each of the arms may be generated with updated cumulative play and rewards counts. Such new beta distributions may then be used for making a next bidding decision on next ad request. Also, in some examples of the method 800, when the method proceeds back to block 804, the arms set that the multi-arm bandit module generates may be an updated arms set based on new or updated training data, which may be based on response rate information resulting from bidding actions performed during performance of the method 800.

The example methods 700, 800 described respectively in FIGS. 7 and 8 may be performed independently of each other or together in combination. For example, a combination of the methods may include after an arms set is generated and provided to the bidding decision system at block 716, the combined method may proceed to block 802, where the multi-arm bandit module receives an arms set of feature combinations. Other ways of combining the example methods 700 and 800 may be possible. Also, other methods of generating a plurality of feature recommendations for a bidding decision module, performing bidding decisions for incoming ad requests from over a network, or combinations thereof, may be performed with fewer than all of the actions associated with the blocks of the example methods 700 and/or 800.

It is intended that the foregoing detailed description be understood as an illustration of selected forms that the invention can take and not as a definition of the invention. It is only the following claims, including all equivalents, which are intended to define the scope of the claimed invention. Finally, it should be noted that any aspect of any of the preferred embodiments described herein can be used alone or in combination with one another.

1. A system for enhanced prediction of response events, the system comprising:
a feature recommendation controller configured to:
generate a model parameter set of model parameters corresponding to a plurality of feature combinations of contextual features and advertisement features, the model parameter set generated based on training data associated with the contextual features and the advertisement features;
select, among the model parameters in the model parameter set, a number of highest-ranked model parameters, wherein the number of highest-ranked model parameters corresponds to a set of feature combinations of the plurality of feature combinations that is expected to yield the highest response rates among the plurality of feature combinations; and
generate an arms set that comprises the set of feature combinations; and
a bidding controller configured to:
receive an incoming ad request; and
send a bid over a network to an exchange for the incoming ad request in response to a maximum sample corresponding to the set of feature combinations in the arms set being greater than a threshold response rate.

2. The system of claim 1, wherein the training data comprises response rate data corresponding to the contextual features and the advertisement features.

3. The system of claim 1, wherein the feature recommendation controller is further configured to generate a set of predicted response event values for the plurality of feature combinations, and generate the model parameter set based on the set of predicted response event values.

4. The system of claim 1, wherein the feature recommendation controller is configured to generate the model parameter set by iteratively updating the model parameter set using stochastic gradient descent.

5. The system of claim 1, wherein each feature combination in the arms set comprises a publisher feature, a user feature, and an advertiser feature.

6. The system of claim 1, wherein the bidding controller is further configured to generate a plurality of beta distributions corresponding to the set of feature combinations in the arms set.

7. The system of claim 6, wherein the bidding controller is further configured to:
generate a set of alpha and beta parameter pairs corresponding to the set of feature combinations in the arms set; and
generate the plurality of beta distributions based on the set of alpha and beta parameter pairs.

8. The system of claim 7, wherein the bidding controller is further configured to sample each beta distribution of the plurality of beta distributions to generate a set of beta distribution samples.

9. The system of claim 8, wherein the bidding controller is further configured to select the maximum sample from the plurality of beta distribution samples.

10. A method for enhanced bidding on received ad requests, the method comprising:
generating, with a multi-arm bandit module, a plurality of beta distributions, each beta distribution being associated with one of a plurality of arms in an arms set, each arm of the plurality of arms being associated with a feature combination of a plurality of feature combinations of contextual features and advertisements features;
sampling, with the multi-arm bandit module, each of the plurality of beta distributions to generate a plurality of beta distribution samples;
selecting, with a sample selection module, a maximum sample of the plurality of beta distribution samples, the maximum sample being associated with an optimal arm of the plurality of arms;
comparing, with a comparator module, the maximum sample with a response rate threshold associated with a pacing rate; and
sending, with a bidding module, a bid for a received ad request over a network to an exchange auction server in response to the maximum sample exceeding the response rate threshold.

11. The method of claim 10, further comprising:
generating, with the multi-arm bandit module, a set of alpha and beta parameter pairs corresponding to the arms set,
wherein generating the plurality of beta distributions comprises generating, with the multi-arm bandit module, the plurality of beta distributions based on the set of alpha and beta parameter pairs.

12. The method of claim 11, wherein alpha parameters of the alpha and beta parameter pairs are based on cumulative reward counts and beta parameters of the alpha and beta parameter pairs are based on the cumulative reward counts and cumulative play counts, each of the cumulative reward counts and each of the cumulative play counts being associated with a respective one of the plurality of arms, the method further comprising:
incrementing, with the multi-arm bandit module, a cumulative play count associated with the optimal arm when the associated maximum sample exceeds the response rate threshold; and
incrementing, with the multi-arm bandit module, a cumulative reward count in response to occurrence of a response event associated with the optimal arm.

13. The method of claim 12, further comprising:
updating, with the multi-arm bandit module, the set of alpha and beta parameter pairs in response to at least one of: incrementing the cumulative play count or incrementing the cumulative reward count.

14. The method of claim 13, wherein updating the set of alpha and beta parameter pairs is performed with the multi-arm bandit module according to the following mathematical formulas:
αᵢ^{t}=αᵢ⁰+rᵢ^{t}, and βᵢ^{t}=βᵢ⁰+nᵢ^{t}−rᵢ^{t},
where αᵢ^{t} is an ith alpha parameter corresponding to an ith arm of the plurality of arms in a current time slot t, βᵢ^{t} is an ith beta parameter corresponding to the ith arm in the current time slot t, αᵢ⁰ is an ith initial alpha parameter value, βᵢ⁰ is an ith initial beta parameter value, rᵢ^{t} is an ith cumulative reward count associated with the ith arm in a current time slot t, and nᵢ^{t} is an ith cumulative play count associated with the ith arm in a current time slot t.

15. The method of claim 10, further comprising:
determining, with an ad request determination module, a first number of ad requests to be received within a current time slot in order for a spend budget to be achieved for the current time slot given a determined pacing rate; and
determining, with a threshold generation module, a threshold minimum response rate among a plurality of response rates that yields a second number of ad requests associated with expected response rates that are greater than the threshold minimum response rate such that the second number of ad requests is closer to the first number of ad requests compared to other numbers of ad requests yielded by other response rates among the plurality of response rates.

16. The method of claim 15, further comprising:
integrating, with the threshold generation module, over a distribution of ad requests as a function of response rate to determine the threshold minimum response rate.

17. The method of claim 15, wherein the response rate threshold is a first response rate threshold associated with the current time slot and the threshold minimum response rate is associated with the current time slot, the method further comprising:
generating, with a threshold smoothing module, the first response rate threshold associated with the current time slot based on the threshold minimum response rate associated with the current time slot and a second response rate threshold associated with a prior time slot.

18. The method of claim 17, wherein generating the first response rate threshold is performed according to the following mathematical formula:
$${μ}_{τ} ( t ) = {μ}_{τ} ( t - 1 ) + \frac{1}{T} ( τ ( t ) - {μ}_{τ} ( t - 1 ) ) ,$$
where t represents the current time slot, (t−1) represents the prior time slot, T represents a total number of time slots, μ_{τ}(t) represents the first response rate threshold associated with the current time slot, μ_{τ}(t−1) represents the second response rate threshold associated with the prior time slot, and τ(t) represents the threshold minimum response rate associated with the current time slot.

19. A non-transitory computer readable medium comprising:
instructions executable by a processor to generate a set of predicted response event values based on a training data for different feature combinations of contextual features and advertisement features;
instructions executable by a processor to iteratively update an initial model parameter set using the set of predicted response event values to generate an updated model parameter set;
instructions executable by a processor to generate an arms set comprising a subset of the different feature combinations, the subset corresponding to a number of highest-ranked model parameters of the updated model parameter set;
instructions executable by a processor to generate a plurality of beta distribution samples, each beta distribution of the plurality of beta distribution samples corresponding to one of the feature combinations in the subset; and
instructions executable by a processor to send a bid for a received ad request over a network to an exchange auction server in response to a comparison between one of the plurality of beta distribution samples and a response rate threshold.

20. The non-transitory computer readable medium of claim 19, wherein the training data comprises response rate data corresponding to the contextual features and the advertisement features.
